(19) United States
(12) Patent Application Publication
(10) Pub. No.: US 2019/0254412 A1
(43) Pub. Date: Aug. 22, 2019

(54) Paint Brush Apparatus With a Dispenser

(71) Applicant: Maxime Gedeon-Janvier, Inwood, NY (US)

(72) Inventor: Maxime Gedeon-Janvier, Inwood, NY (US)

(21) Appl. No.: 16/278,241

(22) Filed: Feb. 18, 2019

Related U.S. Application Data
(60) Provisional application No. 62/633,049, filed on Feb. 20, 2018.

(51) Int. Cl. A46B 11/00; A46B 5/00

(52) U.S. Cl. CPC A46B 11/0055; A46B 5/0095; B44D 3/12; A46B 2200/202; A46B 11/0062; A46B 11/0079

(57) ABSTRACT

A multi-component brush apparatus is described and can be used in the application of any fluid (for example, paint). The brush apparatus includes a cylindrical reservoir for holding a volume of a fluid material, a distributor attached to the cylindrical reservoir and used to transport the fluid from the reservoir along a set of small-sized tubes (pipes) disposed within the brush bristles. A piston is included and engages with the reservoir to advance the movement of the fluid material toward the distributor.

### CROSS-REFERENCE TO RELATED APPLICATIONS

This application claims the benefit of U.S. Provisional Application No. 62/633,049, filed Feb. 20, 2018 and hereby incorporated by reference.

### TECHNICAL FIELD

The present invention relates to a paint brush apparatus and, more particularly, to a multi-part, completely hand-held paint brush apparatus that also includes a reservoir for holding a supply of paint, and a distributor component that functions to deliver the paint from the reservoir to the bristles forming the brush.

### BACKGROUND OF THE INVENTION

Currently, the act of painting (such as, for example, interior or exterior house painting) requires the painter to dip his/her brush tips in the paint contained in a pan or bucket. As the painter pulls the brush up for use, the brush itself needs to be turned, or otherwise maneuvered to keep the paint from dripping off of the brush. Many times, this movement is not successful and paint lands on the floor or other areas where it then needs to be removed. Needless to say, such a mess makes the painting task unnecessarily long.

### SUMMARY OF THE INVENTION

The problems associated with the prior art techniques for applying paint to a brush are addressed by the present invention, which relates to a paint brush apparatus and, more particularly, to a multi-part, completely hand-held paint brush apparatus that also includes a reservoir for holding a supply of paint and distributor component that functions to deliver the paint from the reservoir to the bristles forming the brush.

In accordance with an exemplary embodiment, the present invention takes the form of a multi-component brush apparatus comprising: a cylindrical reservoir for holding a volume of a fluid material and a distributor coupled to a first end termination of the cylindrical reservoir. The distributor includes an inlet port in fluid communication with the cylindrical reservoir and a plurality of outward-extending, parallel pipes for transporting fluid received at the inlet port to a dispensing termination of the brush apparatus. Also included is a piston coupled to a second, opposing end termination of the cylindrical reservoir, where the piston enters the reservoir and advances the movement of the fluid material toward the distributor.

While various portions of the following description will refer to the inventive apparatus as a “paint” brush, and describe filling the reservoir with paint, in its broadest application the apparatus of the present invention may be used with any type of fluid, directing the fluid from the reservoir through the distributor to the brush by the action of the piston. Thus, as the details mention “painting”, this is only for explanatory purposes and does not limit the scope of the invention.

Other and further embodiments and advantages of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a side view of an exemplary multi-component paint brush apparatus formed in accordance with the present invention;

FIG. 2 is a view of the brush apparatus of FIG. 1, in this with the brush head component removed to show the interior components of the distributor;

FIG. 3 contains a pair of diagrams showing the positioning of the distributor pipes within the bristles of the brush head component;

FIG. 4 is an exploded view of the apparatus of FIG. 1;

FIG. 5 is a view of the reservoir component of the apparatus of FIG. 1, illustrating a pair of end caps that may be used to seal the reservoir when not in use;

FIG. 6 is an exploded view of an alternative embodiment of the present invention, in this case including a detachable/movable trimmer element;

FIG. 7 is a side view of the alternative embodiment of FIG. 6, illustrating the placement of the trimmer element adjacent to the brush head component; and

FIG. 8 is an alternative side, similar to FIG. 7, but in this case with the trimmer element turned in the opposite direction to be pointed away from the brush head component.

### DETAILED DESCRIPTION

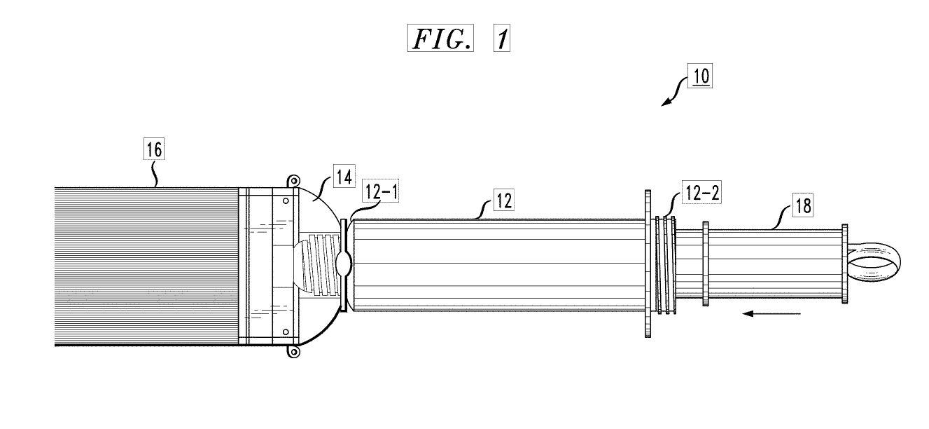

FIG. 1 is a side view of an exemplary multi-part paint brush apparatus 10 formed in accordance with the present invention. As mentioned above, the brush apparatus 10 of the present invention may be used for the application of any fluid (e.g., paint, oil, epoxy, glue, or the like). The reference to “paint brush” is merely for the purposes of explanation and to clearly describe an exemplary situation where the apparatus may be utilized. Thus, while the remainder of the description references “paint brush”, it is to be considered to broadly encompass any type of brush apparatus for applying a liquid material to a surface.

Referring to FIG. 1 in detail, paint brush apparatus 10 is shown as comprising a reservoir 12 for holding a supply of paint/liquid, where the cylindrical form of reservoir 12 allows for it to also function as the paint brush handle. Apparatus 10 further comprises a distributor 14 attached to a first end 12-1 of reservoir 12 and a brush head component 16 attached to distributor 14. A piston 18 is disposed within an open second end 12-2 of reservoir 12 and is used to force the paint/liquid into distributor 14 and ultimately onto brush head component 16.

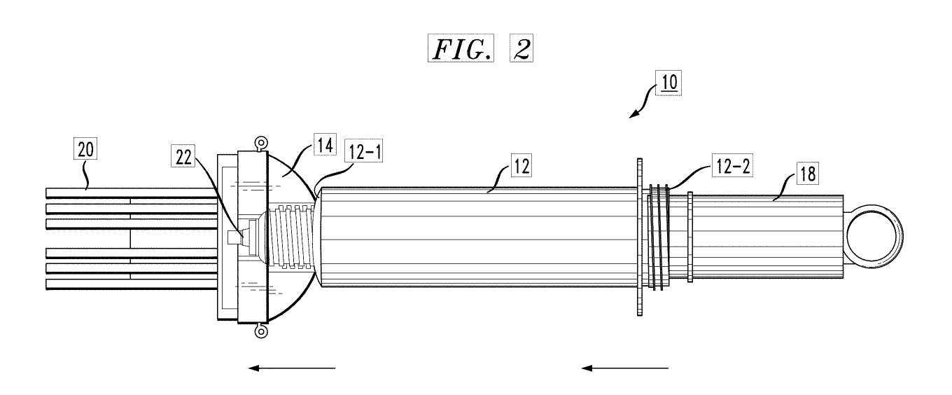

FIG. 2 is an alternative view of paint brush apparatus 10 of FIG. 1, where in this case brush head component 16 has been removed to better illustrate the configuration of distributor 14. In particular, FIG. 2 illustrates distributor 14 as comprising a plurality of parallel small-diameter tubes or channels (also defined as pipes) 20 in fluid communication with an inlet port 22. Thus, in operation, as piston 18 exerts pressure on the fluid (i.e., paint) within reservoir 12, the fluid moves into distributor 14 at inlet port 22, which thereafter directs the fluid along the plurality of pipes 20.

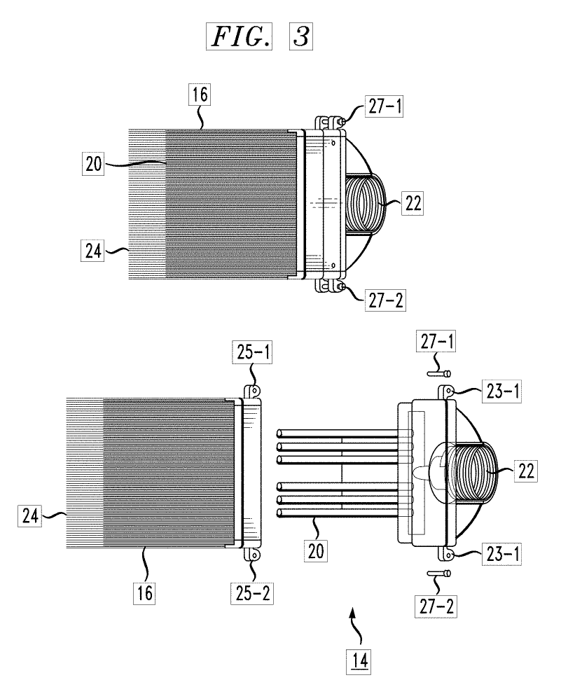

FIG. 3 illustrates the location of pipes 20 within the bristles forming brush head component 16. As the paint exits pipes 20, it will appear at the end terminations 24 of the brush bristles, allowing for the paint to be easily applied. Thus, as the painting progresses, the user merely inserts piston 18 further into reservoir 12, forcing an additional amount of paint through distributor 14 and onto brush head component 16. Also shown in FIG. 3 is an exemplary arrangement for attaching brush head component 16 to distributor 14. Preferably, a releasable type of attachment is used, which aids in the clean-up of all of the elements. As shown, distributor 14 includes a pair of opposing pin locators 23-1, 23-2, and brush head component 16 includes a pair of opposing pin locators 25-1, 25-2. When the two elements are joined together, as shown, pin locators 23 align with pin locators 25. A pair of pins 27-1, 27-2 may then be used to join the two together, where the pins may then be removed at a later point in time when brush head component 16 is to be removed from distributor 14. Various other arrangements for attaching brush head component 16 to distributor 14 are contemplated (such as a side locking arrangement, a clamping arrangement, or the like), and all are considered to fall within the scope of the present invention.

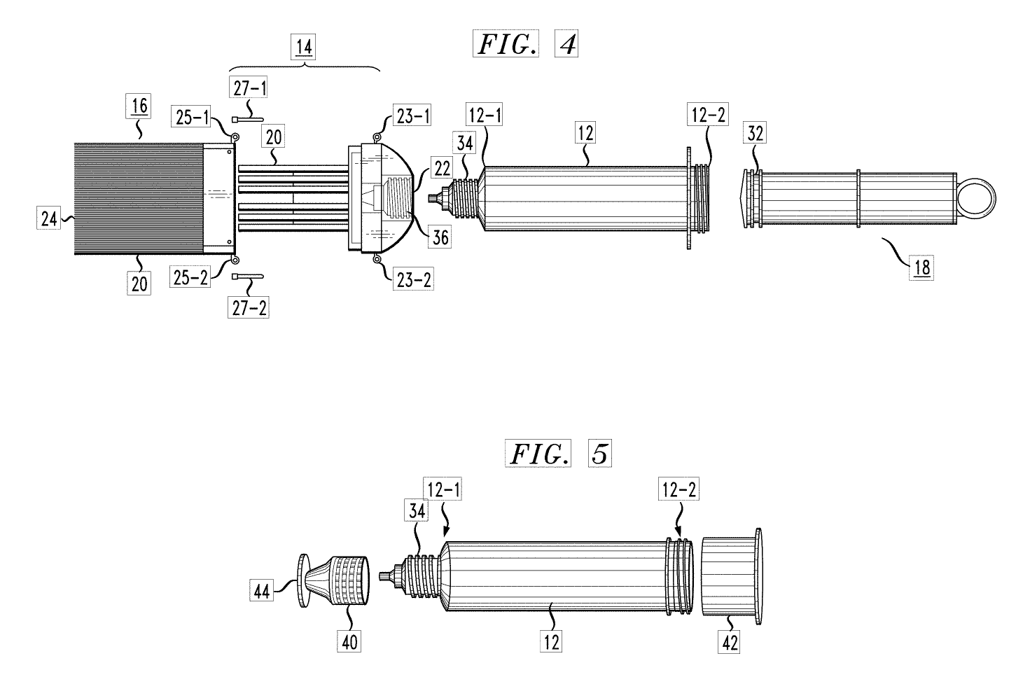

FIG. 4 is an exploded view of multi-part paint brush apparatus 10, illustrating in detail an exemplary configuration useful in attaching the components together in a leak-free manner. In particular, FIG. 4 illustrates a gasket 30 that is disposed around a collar end termination 32 of piston 18. Thus, when piston 18 is inserted within the hollow opening 12-2 of reservoir 12, gasket 30 provides a seal to keep any of the liquid in reservoir 12 from leaking out. As also shown, first end 12-1 of reservoir 12 comprises a threaded configuration 34 (threaded on the outer surface of first end 12-1). The threading on first end 12-1 is configured to mate with an inner threaded surface 36 of inlet port 22 (of distributor 14). In this embodiment, therefore, distributor 14 is screwed onto first end 12-1 of reservoir 12 and securely held in place. A sealant material may be coated on inner threaded surface 36 to further ensure that the connection is leak free. Brush head component 16 is shown as attached to distributor 14 using pin locators 23, 25 with pins 26 in the manner described above in association with FIG. 3.

Advantageously, the configuration of paint brush apparatus 10 of the present invention allows for the user to easily replenish the liquid supply within reservoir 12. Each time the user needs more paint/liquid, he/she may remove (i.e., unscrew) distributor 14 from first end 12-1 of reservoir 12 to expose an opening inlet at end 12-1. The user then inserts end 12-1 of reservoir 12 into the paint supply and draws back piston 18, which will draw the liquid up into reservoir 12. Once re-filled, the combination of brush head component 16 and distributor 14 is screwed back on to first end 12-1 of reservoir 12 and the painting continues. It is also contemplated that the reservoir may be refilled by removing brush head component 16 from distributor 14 and positioning the exposed pipes 20 of distributor 14 into a paint (solution) supply. In this case, the paint is drawn up through pipes 20 of distributor 14 and thereafter into reservoir 12.

It is contemplated that there may be occasions where the painter needs to take a break, and yet intends to return to the job shortly and does not want to clean out reservoir 12. FIG. 5 illustrates reservoir 12 in combination with a pair of end caps 40, 42, which may be screwed onto the opposing end terminations 12-1 and 12-2 of reservoir 12. It is to be understood that piston 18 and distributor 14 are first removed from their connections to reservoir 12 before end caps 40 and 42 are attached. In a preferred embodiment, end cap 40 attached to first end termination 12-1 is configured to including a standing surface 44 such that reservoir 12 may be stored in the vertical position, with the remaining liquid in the reservoir directed downward and into first end termination 12-1. While this is a preferred embodiment, it is not a requirement for the end cap construction.

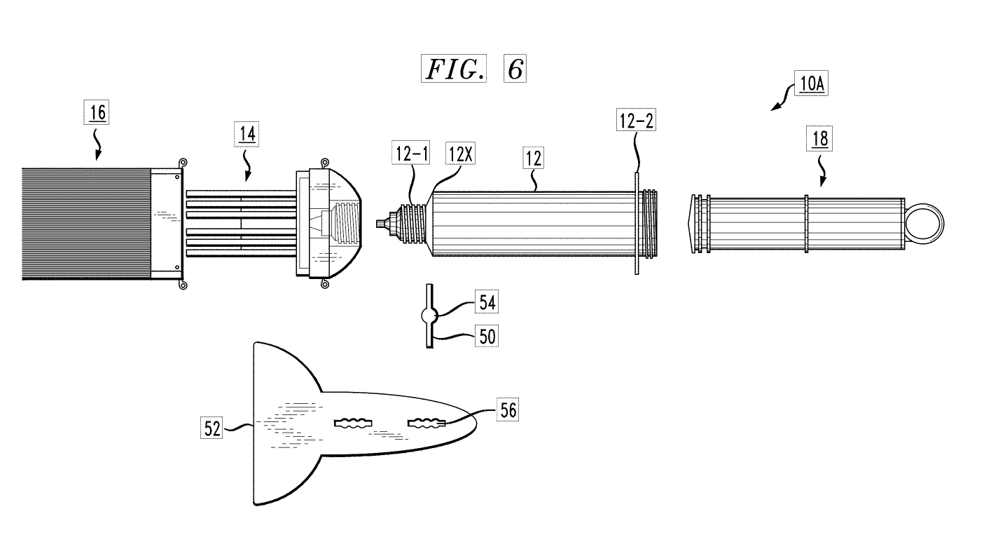

FIG. 6 illustrates, in an exploded view, another embodiment of the present invention, in this case where an attachment ring 50 and a trimmer element 52 are added to the components forming the paint brush apparatus, shown in this embodiment as paint brush apparatus 10A. Trimmer element 52, as known in the art, is typically used to “cut in” or “trim” around edges, window sills, or other framing elements during painting. Advantageously, this embodiment of the present invention allows for trimmer element 52 to be positioned adjacent to brush head component 16 to better facilitate a “one-hand” type of cutting-in technique.

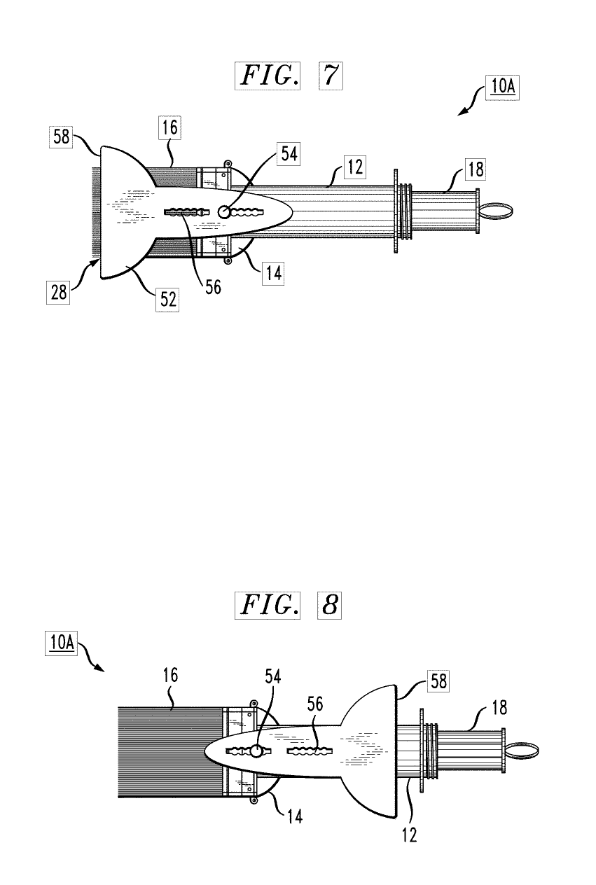

Referring in particular to FIG. 6, attachment ring 50 is sized to fit over the area 12X where first end 12-1 meets the body portion of reservoir 12. As shown, ring 50 is formed to include a mating pin 54 and trimmer element 52 is formed to include a plurality of apertures 56. Thus, the attachment of trimmer element 52 by inserting one of the apertures 56 over mating pin 54 can be used to position blade end 58 at a desired location with respect to brush 16. FIG. 7 shows ring 50 in place over reservoir 12, and trimmer element 52 positioned for use. When not required, trimmer element 52 may be re-positioned along reservoir 12, as shown in FIG. 8.

While various embodiments and features of the inventive multi-component brush apparatus have been described above and shown in the associated drawings as used in the application of paint, it is to be understood that in general the brush apparatus may be used for the application of any type of fluid material. Additionally, there may exist various modifications which may be made to one or more of the specific components forming the multi-component brush apparatus, and remain within the scope of the present invention. Indeed, the scope of the present invention is intended to be limited only by the language of the claims appended hereto.

What is claimed is:

1. A multi-component brush apparatus, comprising:
a cylindrical reservoir for holding a volume of a fluid material;
a distributor coupled to a first end termination of the cylindrical reservoir, the distributor including an inlet port in fluid communication with the cylindrical reservoir and a plurality of outward-extending, parallel pipes for transporting fluid received at the inlet port to a dispensing termination of the brush apparatus; and
a piston coupled to a second, opposing end termination of the cylindrical reservoir, wherein the second, opposing end termination is open, allowing the piston to enter the reservoir and advance the movement of the fluid material toward the distributor.

2. The multi-component brush apparatus of claim 1, further comprising
a brush head component attached to the distributor such that bristles within the brush are aligned with the plurality of parallel pipes.

3. The multi-component brush apparatus of claim 2 wherein the brush head component is removably attached to the distributor.

4. The multi-component brush apparatus of claim 3 wherein the distributor further comprises a first pair of oppositely-positioned locator pins and the brush head component further comprises a second pair of oppositely-positioned locator pins, the second pair disposed in alignment with the first pair upon attachment of the brush head component to the distributor, the multi-component brush apparatus further comprising a pair of pins disposed through the aligned first and second pairs of aligned locator pins, providing releasable attachment of the brush head component to the distributor.

5. The multi-component brush apparatus of claim 1, wherein
the cylindrical reservoir is configured to include an outer threaded surface along the first end termination; and
the inlet port of the distributor is configured to include an inner threaded surface, such that the distributor attaches to the cylindrical reservoir through the mating of the threaded surfaces.

6. The multi-component brush apparatus of claim 1 wherein the piston further comprises a gasket disposed around a first end termination thereof such that as the first end termination enters the open end termination of the cylindrical reservoir, the gasket forms a seal and prevents leaking of any fluid material.

7. The multi-component brush apparatus of claim 1 wherein the apparatus further comprises a pair of end caps for removably covering exposed end terminations of the cylindrical reservoir when not attached to the distributor and the piston.

8. The multi-component brush apparatus of claim 1 wherein the apparatus further comprises a trimmer element removably attached to the apparatus, the trimmer element including a blade end for positioning adjacent to the termination of the bristles forming the brush head component.

9. The multiple-component brush apparatus of claim 8 wherein the apparatus further comprises an attachment ring disposed at the interface between the cylindrical reservoir and the distributor, the attachment ring for removably engaging the trimmer element and configured to control the location of the termination of the blade end with respect to the bristles.

10. The multi-component brush apparatus of claim 9 wherein the attachment ring includes a pin and the trimmer element includes a set of apertures, the trimmer element engaging with the ring by positioning the pin through a selected aperture.
